(19) United States
(12) Patent Application Publication
(10) Pub. No.: US 2012/0073388 A1
(43) Pub. Date: Mar. 29, 2012

(54) FORCE SENSING COMPOSITIONS, DEVICES AND METHODS

(75) Inventor: Luis Paulo Felipe Chibante, Fredericton (CA)

(73) Assignee: UNIVERSITY OF NEW BRUNSWICK, Fredericton, NB (CA)

(21) Appl. No.: 13/322,069

(22) PCT Filed: May 21, 2010
(86) PCT No.: PCT/CA10/00770

§ 371 Date: Dec. 13, 2011

Related U.S. Application Data
(60) Provisional application No. 61/180,830, filed on May 22, 2009.

(51) Int. Cl. G01L 1/22; H01B 1/22; H01B 1/24; B82Y 99/00

(52) U.S. Cl. 73/862.627; 252/500; 252/511; 252/512; 73/862.621; 977/779; 977/742

(57) ABSTRACT

A composite comprising a pliable base material and nanoscale anisotropic conductive particles; whereby deformation of the composite causes a change in the electrical conductivity of the composite.

### FIELD OF THE INVENTION

The present invention relates to force sensing devices and associated methods in general, and piezoresistive compositions and devices and associated methods in particular.

### BACKGROUND

In general, conductive material (sometimes called filler) can be added to a non-conductive or poorly conductive base material (also sometimes referred to as an insulative matrix) to form a composite which exhibits altered (often improved) conductivity. Since the conductivity of such composites can be altered in response to deformation of the composite by force applied to it, such composites can be used in force sensing devices for such applications as touch pads for electronic devices.

The amount of conductive material added to the base material is called the loading. The change with loading of filler is known to those skilled in the art as a percolation curve, wherein a minimum volume of filler (threshold) is needed to change the conductive state of the composite. There is a large change in conductivity with loading (greater than a factor of about 1000), wherein the conductive fillers have just achieved a percolation pathway through the composite. Further loading will result in only moderate changes in conductivity, as additional pathways are cumulative. With spherical particles such as carbon black, the percolation threshold is often greater than about 10 vol %. In order to achieve desired conductivity, a higher loading may be required. Generally, the higher the loading, the stiffer the base material becomes, making it less deformable in response to a given force such as a finger touch, and in the case of a touch pad, can lead to poor sensitivity to finger touches. Furthermore, a higher loading does not necessarily lead to a sufficient improvement in conductivity of the base material.

### SUMMARY OF THE INVENTION

In one aspect, the present invention relates to the use of nanoscale anisotropic conductive fillers in elastomers that exhibit large compliance (for example, deformation greater than about 1%) causing a proportionate change in the electrical conductivity of the elastomer/conductive filler composite.

In another aspect, the present invention relates to the use of nanoscale anisotropic conductive additives in elastomers that are pliable, deformable, and/or flexible such that a force applied to the elastomer composite causes a proportionate change in the electrical conductivity of said composite. Anisotropic refers to the shape of the additives such that the length is greater than the width, giving elongated structures. The elastomers are also moldable into various shapes.

In a further aspect, the present invention relates to a polymer composition comprising an elastomeric base polymer with nanoscale anisotropic additives wherein the composition has improved piezoresistive properties and stability. The nanoscale anisotropic additives include structures with diameters less than about 500 nm and length-to-diameter ratio greater than about 2, and with morphologies that are tubular (for example, nanorods, nanowhiskers, and nanowires) or in the form of platelets of thickness less than about 100 nm.

The nanoscale anisotropic additives in elastomers in one embodiment possess changes in electrical conductivity with applied force greater than 10% over a broad pressure range and wherein the applied force is correlated to a measured difference in electrical conductance.

The present invention in another aspect relates to force sensing devices including an elastomeric substrate containing nanoscale particles. In one embodiment, the device further includes a first and a second electrode electrically connected to the elastomeric substrate whereby resistivity (R) of the substrate can be measured. Since conductivity is the inverse of resistivity, a person of ordinary skill in the art would understand that conductivity can be derived from the resistivity measurement.

In another embodiment, the device further includes a power supply for applying a voltage and/or current across the first and second electrodes.

In another aspect, this invention discloses a method for detecting applied force comprising the steps of providing a pliable substrate containing conductive nanoscale particles, applying a voltage and/or current to the substrate, taking a first measurement of resistivity and/or conductivity of the substrate, deforming the substrate, taking a second measurement of resistivity and/or conductivity of the substrate, determining the difference between the first and second measurements, and correlating the difference to the degree of deformation. In a further embodiment, the difference can be correlated to the magnitude of a force applied to the substrate.

In a further aspect, the present invention relates to a composite comprising a pliable base material and nanoscale anisotropic conductive particles; whereby deformation of the composite causes a change in the electrical conductivity of the composite.

In a further aspect, the present invention relates to a composite comprising a pliable base material and nanoscale anisotropic conductive particles; whereby the composite forms a piezoresistive layer on a substrate which may or may not be deformable.

In a further aspect, the present invention relates to a force sensing device comprising a composite comprising a pliable base material and nanoscale anisotropic conductive particles, at least two electrodes in electrical contact with the composite and a voltage supply connected to the electrodes.

In a still further aspect, the present invention relates to a method for detecting applied force comprising a composite comprising a pliable base material and nanoscale anisotropic conductive particles, applying a voltage and/or current to the composite; taking a first measurement of resistivity and/or conductivity of the composite; deforming the substrate; taking a second measurement of resistivity and/or conductivity of the composite; determining the difference between the first and second measurements; and correlating the difference to the degree of deformation

### BRIEF DESCRIPTION OF THE DRAWINGS

FIG. 1 is a photograph of a polymer composite sheet according to another embodiment of the present invention;

FIG. 2 is a photograph of a polymer composite sheet electrically connected to electrodes according to another embodiment of the present invention;

FIG. 3a is a schematic of a force sensing device according to one embodiment of the present invention;

FIG. 3b is the force sensing device of FIG. 3a with a force applied;

FIG. 3c is a graph of relative resistivity plots for the device of FIGS. 3a and 3b;

FIG. 4a is a schematic of a force sensing device according to another embodiment of the present invention;

FIG. 4b is the force sensing device of FIG. 4a with a force applied;

FIG. 4c is a graph of relative resistivity plots for the device of FIGS. 4a and 4b; and

FIG. 5 is a graph showing conductance as a function of applied compressive force for a elastomer composition according to one embodiment of the present invention.

### DETAILED DESCRIPTION OF THE PREFERRED EMBODIMENTS

Piezoresistivity is the effect of changing resistivity (and inversely, conductivity) of a material as a result of an applied external force. The present invention in one embodiment comprises a substrate containing nanoscale particles wherein the substrate has piezoresistive properties. The nanoscale particles are anisotropic and electrically conductive, preferably with a length-to-diameter ratio greater than two and diameters less than 500 nm. Examples of such materials include carbon, metallic nanowires (e.g. Cu, Ag, Au, Zn), metal whiskers, graphitic nanofibers, and plate-like structures. In one embodiment, the nanoscale particles are carbon nanotubes. In another embodiment, the substrate is an elastomer.

Without being bound by theory, anisotropic particles according to the present invention create long conductive paths inside the substrate, reducing the density of contact points required for charge carriers to migrate. This results in a significant decrease in the amount of anisotropic particles needed in the substrate as well as increasing the uniformity and sensitivity of the piezoresisitive effect.

In addition, in correlation with the known percolation curve of resisitivity as a function of loading, there is also a sensitivity of the piezoelectric effect as a function of loading. The change in resistance with applied force is smaller at either end of the loading curve, with the greatest change in resistance with applied force occurring near the threshold. In one embodiment of the present invention, this allows a composite material with piezorsistive properties to be optimized for the sensitivity and range of applied force from human touch levels (< about 1 ounce) to weighing heavy equipment (greater than about 1000 lbs).

Carbon Nanotubes

Nanotubes that can be used as conductive particles in the compositions of the present invention include carbon nanotubes, including HiPCO single-walled nanotubes (SWNT) produced by Carbon Nanotechnologies, multiwall nanotubes (MWNT) known as Babytubes from Bayer Materials, and vapor grown carbon fibers (VGCF) from Pyrograph Products Inc., a subsidiary of Applied Sciences, Inc.

There are different grades of carbon nanotubes available in the market. Often these grades contain contaminants such as small graphitic nanoparticles that are low conductivity materials, which minimally contribute to physical properties if at all. Purification of the nanotubes, while not necessary, can advantageously be employed to remove such contaminants. Gas phase purification processes are preferred over aqueous purification processes to remove amorphous carbons and sublime volatile metals under inert conditions to enrich the nanotube abundance. This affords processable nanotubes, while maintaining a loose open structure that increases dispensability. The nanotubes overwhelm the fellow species. On the other hand, aqueous purification generally results in agglomerated products that are more intractable to process and disperse in polymers. The aqueous routes often used give a sticky residue which coats the nanotubes and acts like binding glue. The residue can be oxidized off, but at the expense of good nanotube yield.

Elastomer Base Material

Preferably, elastomeric polymers are used in piezoelastic composites according to the present invention. Elastomeric polymers which can be used in the present invention are thermally cured (with or without sulfur) or light-cured elastomers because of their processability, high elasticity and temperature stability.

Without being bound by theory, the elasticity of elastomeric polymers is derived from the ability of the long chains to reconfigure themselves to distribute an applied force. The covalent cross-linkages ensure that the elastomer will return to its original state when the force is removed. As a result of this extreme flexibility, elastomers can reversibly extend up to about 1000%.

Elastomers usable in the present invention include but are not limited to: unsaturated rubbers cured by sulfur vulcanization (such as natural rubber, polyisoprene, polybutadiene, styrene-butadiene, and nitrile rubber); saturated rubber not cured by sulfur (such as ethylene propylene diene rubber, silicones, ethylene vinyl acetate); thermoplastic Elastomers and thermoplastic polyurethanes. The elastomer can be a silicone, such as polydimethylsiloxanes, Dupont Sylgard or Dow Silastic.

Examples of Mixing Nanotubes Into Elastomers

The mixing of nanotubes into the elastomer fluid base has been performed by hand mixing, dual centrifugal mixing, ball milling, or solvent mixing. Additionally, an example of a piezoresistive material is demonstrated with shear mixing in a three-roll.

Hand mixing: This was done by adding the nanotube solids to the elastomer fluid base and mixing by hand with a laboratory spatula, working the material until visual homogeneity is obtained. This would typically require 10-15 minutes.

Dual Centrifugal mixing: A FlackTek SpeedMixer™ DAC 150 FVZ-K manufactured by Hauschild Engineering can be used to mix the nanotubes and the elastomer fluid base. This is an economical laboratory-sized instrument for the rapid mixing and grinding of materials that would otherwise require large amounts of time and effort to mix with the added advantage of a cartridge lid, enabling the user to mix directly into syringes or cartridges. The FlackTek SpeedMixer DAC 150 FVZ(K) works by spinning a high speed-mixing arm at speeds up to 3,500 rpm in one direction while the basket rotates in the opposite direction (Dual Asymmetric Centrifuge). This combination of forces in different planes and the action of small glass beads in the container enable fast mixing.

Ball Milling: A well dispersed mixture of nanotubes in an elastomer base can be prepared by ball milling in a ceramic jar with steel ball media for 1-24 hr at rotation speeds of 60-120 rpm. The ball media are easily removed, producing a homogeneous nanotube/elastomer suspension.

Solvent mixing: A nanotube/toluene solution can be prepared by mixing the desired amount of nanotubes in a solvent. For example, the desired amount of nanotubes was mixed in 50 ml of toluene. This suspension was sonicated using a W-385 Ultrasonic Processor (Heat Systems-Ultrasonics Inc) with a pulse sequence of two seconds on and one second off for five minutes. This sequence was repeated three times for a total dispersion time of 15 minutes. After the nanotubes were well dispersed in the solvent, the elastomer fluid base was added and mixed on a magnetic stirrer for 5 minutes. The solvent was removed using a Rotovap at 65° C. and the final mixture was placed in a drying oven at 125° C. until constant mass was achieved (usually overnight).

With the three methods, trial mixing runs were performed to assess final viscosity. Loadings above 15 vol % produced very thick pastes at room temperature. As a guide, a range of loadings were produced that simulated viscosities of commercial polymer pastes.

Physical Properties of Nano-Elastomers

Dispersion, stability and temperature properties were evaluated using microscopic analysis, rheometry, conductivity, and gravimetric analysis.

Electron Microscopic Analysis

A unique property of these nano-composites is that, even with moderate loading of nanotubes, they are electrically conductive. These composites can be placed directly in an SEM with minimal charging effects from the electron beam.

Dispersion on the sub-micron scale was evaluated using a JEOL Environmental SEM. The nanotubes were readily evident. In general, speed mixing and solvent mixing improve dispersion of the nanotubes into the polymer compared to the hand mixed systems. However, with the more fragile VGCF nanotubes, excessive mechanical mixing by the Speed Mixer shortens the tubes.

Filler Effect

Different types of fillers (e.g. VGCF, MWNT, SWNT and conductive acetylene carbon black (ACB)) were added to the different polymers in order to determine the best nanotube elastomer system in terms of conductivity.

All systems were mixed in a speed mixer for 8 minutes at 3,500 rpm, using a nanotube content of 7 wt %. After mixing, a difference in dispersion was seen between the systems. The VGCF and ACB systems showed good apparent dispersion, while the SWNT systems showed visible agglomerates and poor dispersion, which could negatively affect the conductivity results.

Variation was seen on the normalized conductivity of Silicone and PDMS when adding different filler types. In both cases, the multiwall systems had a higher increase of conductivity than the SWNT, which economically is a favorable result since MWNT is less costly and easier to manufacture. To confirm the contribution of nanotubes, a control filler (e.g. ACB) mixed under similar conditions was used for comparison.

A higher conductivity effect was expected on the SWNT systems since these nanotubes have less defects, are longer and have a higher conductivity value than MWNT. It is possible that these lower values are due to a bad dispersion of the SWNT, so an attempt to improve mixing on these systems is a problem to be addressed in order to have a better comparison. It is also important to notice that adding nanotubes instead of the conductive control filler ACB increases conductivity almost by 100%.

Mixing Effect

Different mixing techniques were used in order to study the dispersion effect on conductivity. The polymers were mixed with 7 wt % nanotubes by a hand mixing process (HM), with a speed mixer for 2 minutes (SM 2) or 8 minutes (SM 8), and using solvent mixing.

Results show that there is not a considerable change of conductivity when going from a hand mixed elastomer to a speed mixed one. This effect is possibly due to competing effects occurring in the polymer fluid base: decrease of conductivity with shortening of tubes due to mechanical mixing and increase of conductivity with better dispersion.

In the case of the solvent mixed PDMS/nanotube, a noticeable increase (28% relative to HM) of conductivity is seen. This suggests that improved dispersion with minimum length breakage benefits conductivity.

Example of Making a Piezoresistive Nanocomposite

To create a 7 wt % sample of a Carbon Nanotube (CNT) SYLGARD composite, 23 g of CNT was added to 278g of SYLGARD 184 Silicone Elastomer base. A three roll mill 2″×4.5″ S/S ERWEKA AR400 was used to achieve high sheer dispersion mixing between the nanotubes and elastomer base.

The material was passed through the mill with spacing 2 (˜200 μm), and then repeated with the spacing distance set at 0 (touching contact).

The difference between elastomer base hand-mixed with nanotubes and an elastomer base mixed using the rolling mill was observed on deposited films on a glass substrate. The hand-mixed portion had large agglomerates of material sitting on the clear polymer. The roll milled deposit was much more uniform giving a highly tinted black film.

After mixing, 27.8 g of the curing agent was then added to the material. This was then degassed for 20 minutes in a vacuum chamber (<1 Torr) at room temperature.

Finally, the material was placed in a 7½″×8″ mold to create a 2 mm uniform thick sample (7%). The mold was then placed in a heating oven at 150° C. for 20 minutes to cure. A 6″ square sample was removed from the mold.

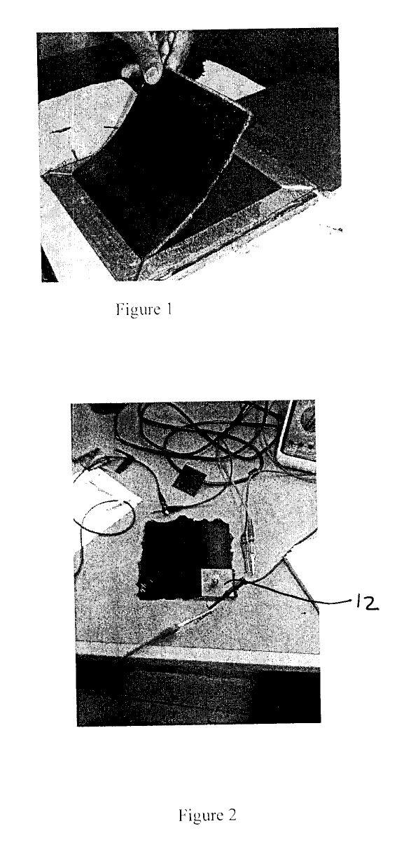

Devices from the material were made. Referring to FIGS. 1 and 2, the conductance of the sample was measured by placing the sample between a pair of 5 cm×5 cm copper plate electrodes 12 (only one shown) and creating a voltage divider circuit. Force was applied to the sample by placing a series of weights ranging from 50 g to 2 kg on the sample and recording the voltage drop across the sample. A person of ordinary skill in the art would understand that the electrodes can be other types of conductive material, and can be in other configurations such as sheets, wires, points, etc. Furthermore, the electrodes may be embedded within the sample or contacting surfaces of the sample.

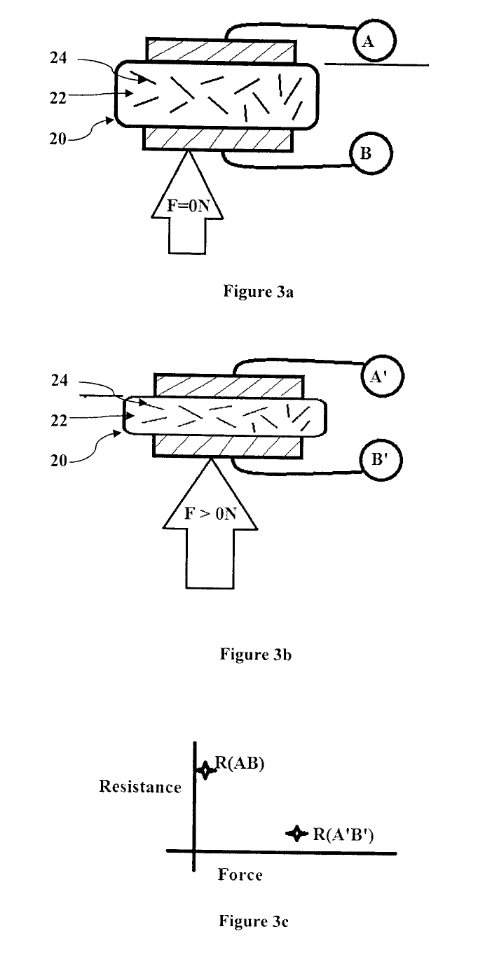

FIG. 3a is a schematic representing a cross-section of a force sensing device according to an embodiment of the present invention. A composite indicated generally at 20 comprising an elastomer substrate 22 and nanoscale anisotropic particles 24 is situated between electrodes A and B in electrical contact with the composite. In one embodiment, the electrodes AB/A′B′ are connected to a measuring circuit to monitor changes in voltage and current in the composite.

With no force (F=ON) applied to the composite 20, the bulk resistance of the composite 20 was measured and plotted on the graph of FIG. 3c as R(AB).

FIG. 3b is a schematic representing a cross-section of the device of FIG. 3a with a force (F>ON) applied to the composite 20. A′ and B′ are the same electrodes as electrodes A and B in FIG. 3a. The bulk resistance through the composite 20 was measured across A′ and B′ and plotted on the graph of FIG. 3c as R(A′B′). Comparing the relative resistivity of R(AB) and R(A′B′), a drop in bulk resistance was noted when a force is applied to the composite 20.

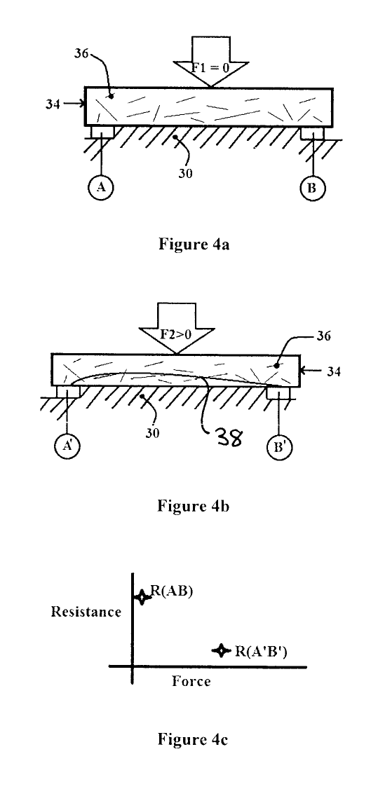

Referring to FIG. 4a, a device according to an embodiment of the present invention comprises a substrate 30 and a piezoresistive composite 32 comprising an elastomer layer 34 and nanoscale anisotropic particles 36. In certain embodiments, the substrate can be a flexible material such as a flexible covering for a mobile phone, or a hard material such as the shell of a mobile phone or other electronic device. The thinner the layer 34, the less voltage that is required to measure resistance in the material. In certain embodiments of the invention, the layer 34 can range from about 50 μm to about 4 mm. In an embodiment of the present invention, the layer 34 can be a thin film. The surface conductance of the layer 34 can be monitored as an alternative to monitoring bulk resistance of a composite such as composite 20 of FIGS. 3a and 3b.

The layer 34 can be applied to the substrate using conventional application methods. For example, the layer 34 can be produced as a separate layer and then attached to the substrate 30 by for example an adhesive. The layer 34 can also be printed on the substrate by spraying, surface moulding, screen printing, ink jet printing, and rolling on.

Electrodes A and B and A′ and B′ are the same which can be a number of configurations, and are positioned on the same side (e.g. either top or bottom) of the layer 34. With no force (F1=0) is applied to the layer 34, the surface resistance of the layer 34 was measured and plotted on the graph of FIG. 4c as R(AB).

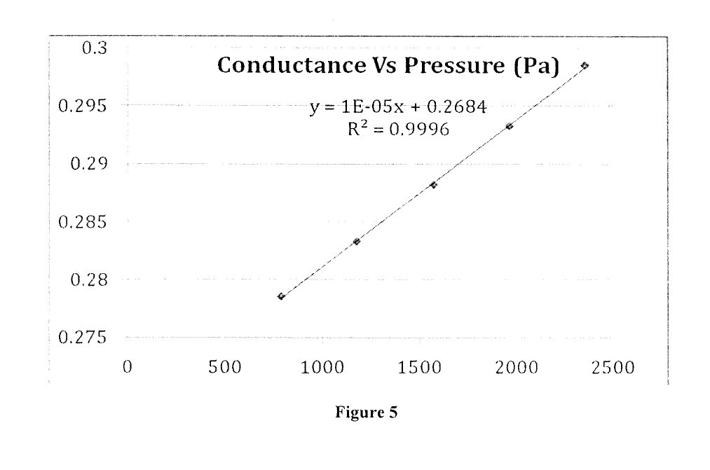

Referring to FIG. 4b, force (F2>0) was applied to the sample by placing a series of weights ranging from 50 g to 2 kg on the sample and recording the voltage drop across the sample and plotted on the graph of FIG. 4c as R(A′B′). The curved line 38 in the layer 34 of FIG. 4b represents a conductive path between the electrodes A′ and B′. Comparing the relative resistivity of R(AB) and R(A′B′), a drop in the surface resistance was noted when a force is applied to the layer 34. The equation V=IR can be used where where V is the potential difference measured across the resistance in units of volts; I is the current through the resistance in units of amperes and R is the resistance of the composite in units of ohms. The bulk conductance (1/R) measured as siemens/meter through the sample correlates with the applied force as illustrated in the plot of FIG. 5. Referring to FIG. 5, the relation is linear, reversible and repeatable over many cycles which are ideal properties for device application.

A similar correlation was observed with the surface conductive mode illustrated in FIGS. 4a and 4b.

Since the material is elastomeric, the ability to produce force sensors that are highly compliant (deformation greater than 5%) compared to known force sensors is possible. This facilitates the creation of a whole new class of flexible, non-metallic sensing materials that can be readily molded into any shape using common plastic processing manufacturing methods.

The invention also allows for any suitable shape of electrode and elastomer assembly to be used in various devices. In other embodiments, the elastomer is used in, but not limited to, molded grips for handles, complex curved surfaces for footwear inserts, cellular phone casings, keyboard covers, and planar assemblies, where a force sensing device is desired such as for finger touch input.

The foregoing description of the invention is intended to be a description of preferred embodiments. Various changes in the details of the described elastomers and methods of use can be made without departing from the intended scope of this invention.

1. A composite comprising:
a pliable base material and nanoscale conductive particles; whereby deformation of the composite causes a change in the electrical conductivity of the composite.

2. The composite of claim 1 wherein the pliable material is an elastomer.

3. The composite of claim 2 wherein the conductive particles are anisotropic.

4. The composite of claim 3 wherein the conductive particles are tubular.

5. The composite of claim 2 wherein the conductive particles are selected from the group consisting of nanotubes, nanorods, nanowhiskers and nanowires.

6. The composite of claim 2 wherein the conductive particles are carbon nanotubes.

7. The composite of claim 2 wherein the conductive particles have diameters less than about 500 nm.

8. The composite of claim 2 wherein the conductive particles have a length-to-diameter ratio of greater than about 2.

9. The composite of claim 2 wherein the conductive particles are platelets.

10. The composite of claim 2 wherein the conductive particles are selected from the group consisting of carbon and conductive metals.

11. The composite of claim 2 wherein the elastomer is polydimethyl-siloxane.

12. The composite of claim 2 further comprising a substrate and wherein the composite forms a piezoresistive layer on the surface of the substrate.

13. A force sensing device comprising the composite of claim 3 further comprising at least two electrodes in electrical contact with the substrate and wherein the electrodes are connectable to a power supply.

14. The device of claim 13 wherein the electrodes are on opposing surfaces of the composite.

15. The device of claim 13 wherein the electrodes are on the same surface of the composite.

16. The device of claim 13 wherein the composite is a thin film.

17. The device of claim 16 wherein the thin film is printed on the substrate.

18. A method for detecting applied force comprising:
providing the composite of claim 1;
applying a voltage and/or current to the composite;
taking a first measurement of resistivity and/or conductivity of the composite;
deforming the substrate;
taking a second measurement of resistivity and/or conductivity of the composite;
determining the difference between the first and second measurements; and
correlating the difference to the degree of deformation

19. The method of claim 18 further comprising correlating the difference to the magnitude of a force applied to the composite.
